(19) United States
(12) Patent Application Publication
(10) Pub. No.: US 2021/0336516 A1
(43) Pub. Date: Oct. 28, 2021

(54) MANUFACTURING METHOD OF IRON CORE, IRON CORE, AND STATOR

(71) Applicant: Panasonic Intellectual Property Management Co., Ltd., Osaka (JP)

(72) Inventors: YUKIO NISHIKAWA, Osaka (JP); MITSUO SAITOH, Osaka (JP)

(21) Appl. No.: 17/219,961

(22) Filed: Apr. 1, 2021

(30) Foreign Application Priority Data
Apr. 22, 2020 (JP) 2020-075902

(51) Int. Cl. H02K 15/02; H02K 1/14

(52) U.S. Cl. CPC H02K 15/022; H02K 1/146

(57) ABSTRACT

A manufacturing method of manufacturing an iron core includes connecting a plurality of iron core pieces each including a tooth portion and a yoke portion in a strip shape, connecting the iron core pieces adjacent to each other by a connection portion, and forming a continuous iron core piece provided line-symmetrically with reference to the connection portion. A laminated body is formed by bending and superimposing the iron core pieces adjacent to each other while the connection portion is used as a symmetry axis. A pressure is applied in a laminating direction of the laminated body to fix the laminated body, and a coil is provided in the tooth portion. In this manner, it is possible to realize a manufacturing method of an iron core, which have a high material yield, high productivity, and excellent magnetic properties by using a thin iron core piece.

### BACKGROUND

### 1. Technical Field

The present disclosure relates to a manufacturing method of an iron core, an iron core, and a stator.

### 2. Description of the Related Art

In the related art, an iron core (also referred to as a stator core) used for a stator of a motor is formed as follows. A metal plate is first punched by using a press mold device to form a plurality of iron core pieces. The formed iron core pieces are laminated and caulked and joined to each other to manufacture the iron core.

According to the manufacturing method of the above-described iron core, the iron core having a satisfactorily accurate shape can be manufactured. On the other hand, each of the iron core pieces configuring the iron core has an annular shape having an opening portion for accommodating a rotor in a center. Therefore, when the iron core piece is formed by punching the metal plate, a material of the metal plate is largely wasted, and a material yield is decreased.

As a method for eliminating a decrease in the material yield, for example, Japanese Patent Unexamined Publication No. 1-264548 discloses a method as follows. Japanese Patent Unexamined Publication No. 1-264548 discloses a method of manufacturing an iron core by forming the iron core piece having a strip shape by punching the metal plate and spirally winding and laminating the iron core piece.

Specifically, first, a continuous punching process is performed on an elongated iron plate. In this manner, an iron core piece connection body is formed in which the iron core pieces having a fan shape are connected to each other via a connection portion. Next, a laminating jig is used. The iron core piece connection body is spirally wound and laminated in an annular shape while each connection portion is bent and deformed. The laminated iron core piece connection bodies are caulked and joined to each other.

As another manufacturing method of the iron core for eliminating the decrease in the material yield, for example, Japanese Patent Unexamined Publication No. 2008-263699 discloses a method as follows. Japanese Patent Unexamined Publication No. 2008-263699 discloses a method of crushing a bent portion of a laminated body formed by bending a continuous iron core piece in a zigzag manner so that both end portions in a laminating direction are substantially parallel to each other.

However, according to the method disclosed in Japanese Patent Unexamined Publication No. 1-264548, when a connection portion is bent and plastically deformed, a plate thickness of an iron core piece connection body is changed (for example, swelling).

In general, for example, as a material for the iron core piece, an electromagnetic steel plate thinned in order to improve magnetic properties of the iron core, or an amorphous ribbon having excellent soft magnetic properties and thinner than the electromagnetic steel plate is used.

However, when the plate thickness of the iron core piece is thin, rigidity of the above-described material is reduced. Consequently, plastic deformation utilizing a change in the plate thickness is less likely to occur. That is, according to the method disclosed in Japanese Patent Unexamined Publication No. 1-264548, the connection portion cannot be accurately bent, and the iron core piece connection body cannot be accurately laminated.

On the other hand, according to the method disclosed in Japanese Patent Unexamined Publication No. 2008-263699, a tooth portion is bent. Therefore, a complicated shape (for example, a curved shape) required for improving the magnetic properties cannot be formed in the tooth portion.

In general, it is effective to perform heat treatment in order to improve the soft magnetic properties of the amorphous ribbon. However, the amorphous ribbon is brittle due to the heat treatment. Therefore, according to the methods disclosed in Japanese Patent Unexamined Publication No. 1-264548 and Japanese Patent Unexamined Publication No. 2008-263699 in which the bending process is utilized, when the amorphous ribbon is used, it is difficult to manufacture the iron core having excellent magnetic properties.

### SUMMARY

The present disclosure provides a manufacturing method of manufacturing an iron core, an iron core, and a stator, which have a high material yield, high productivity, and excellent magnetic properties by using a thin iron core piece.

According to an aspect of the present disclosure, there is provided a manufacturing method of manufacturing an iron core which includes forming a continuous iron core piece in which a plurality of iron core pieces each including a tooth portion and a yoke portion are connected in a strip shape and the iron core pieces adjacent to each other are connected by a connection portion, and which is provided line-symmetrically with reference to the connection portion. A laminated body is formed by bending and superimposing the iron core pieces adjacent to each other while the connection portion is used as a symmetry axis. A pressure is applied in a laminating direction of the laminated body to fix the laminated body, and a coil is provided in the tooth portion to manufacture the iron core.

According to another aspect of the present disclosure, there is provided an iron core including a laminated body including a tooth portion and a yoke portion, and a coil provided in the tooth portion. The laminated body is formed by connecting a plurality of iron core pieces including a tooth portion and a yoke portion in a strip shape, connecting the iron core pieces adjacent to each other by a connection portion, and forming a continuous iron core piece provided line-symmetrically with reference to the connection portion. The iron core is formed by bending and superimposing the iron core pieces adjacent to each other while the connection portion is used as a symmetry axis.

According to still another aspect of the present disclosure, there is provided a stator including the iron core according to the aspect of the present disclosure.

According to the present disclosure, it is possible to provide the manufacturing method of the iron core, the iron core, and the stator, which have a high material yield, high productivity, and excellent magnetic properties by using a thin iron core piece.

### BRIEF DESCRIPTION OF THE DRAWINGS

FIG. 1 is a top view of a continuous iron core piece according to Exemplary embodiment 1 of the present disclosure;

FIG. 2 is an image diagram of a step of bending the continuous iron core piece according to Exemplary embodiment 1;

FIG. 3A is a top view of a laminated body according to Exemplary embodiment 1;

FIG. 3B is a side view of the laminated body according to Exemplary embodiment 1;

FIG. 4A is a top view of a split iron core (before a bent portion is cut) according to Exemplary embodiment 1;

FIG. 4B is a side view of the split iron core (before the bent portion is cut) according to Exemplary embodiment 1;

FIG. 5A is a top view of the split iron core (after the bent portion is cut) according to Exemplary embodiment 1;

FIG. 5B is a side view of the split iron core (after the bent portion is cut) according to Exemplary embodiment 1;

FIG. 6A is a top view of a stator according to Exemplary embodiment 1;

FIG. 6B is a side view of the stator according to Exemplary embodiment 1;

FIG. 7 is a top view of a continuous iron core piece according to Exemplary embodiment 2 of the present disclosure;

FIG. 8A is a top view of a laminated body according to Exemplary embodiment 2;

FIG. 8B is a side view of the laminated body according to Exemplary embodiment 2;

FIG. 9A is a top view of a stator according to Exemplary embodiment 2;

FIG. 9B is a side view of the stator according to Exemplary embodiment 2;

FIG. 10A is a top view of a split iron core (before heat treatment) according to Exemplary embodiment 3 of the present disclosure;

FIG. 10B is a side view of the split iron core (before heat treatment) according to Exemplary embodiment 3;

FIG. 11A is a top view of the split iron core (after heat treatment) according to Exemplary embodiment 3;

FIG. 11B is a side view of the split iron core (after heat treatment) according to Exemplary embodiment 3;

FIG. 12A is a top view of the split iron core (after a residual portion is cut) according to Exemplary embodiment 3;

FIG. 12B is a side view of the split iron core (after the residual portion is cut) according to Exemplary embodiment 3;

FIG. 13A is a top view of a split iron core (before heat treatment) according to Exemplary embodiment 4 of the present disclosure;

FIG. 13B is a side view of the split iron core (before heat treatment) according to Exemplary embodiment 4;

FIG. 14A is a top view of the split iron core (after heat treatment) according to Exemplary embodiment 4; and

FIG. 14B is a side view of the split iron core (after heat treatment) according to Exemplary embodiment 4.

### DETAILED DESCRIPTION

Hereinafter, embodiments of the present disclosure will be described with reference to the drawings. The same reference numerals will be assigned to components common to those in each drawing, and description thereof will be omitted as appropriate.

### Exemplary Embodiment 1

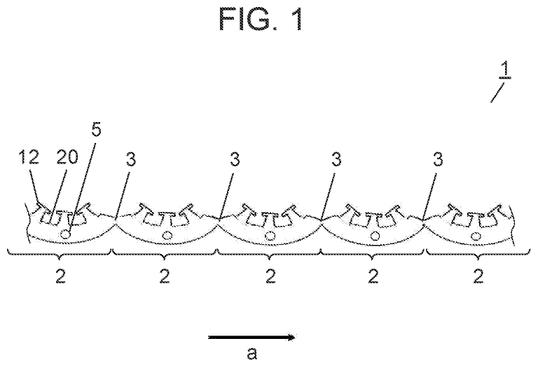

Hereinafter, continuous iron core piece 1 of Exemplary embodiment 1 will be described with reference to FIG. 1. FIG. 1 is a top view of continuous iron core piece 1.

As illustrated in FIG. 1, continuous iron core piece 1 of Exemplary embodiment 1 is a member in which a plurality of iron core pieces 2 are connected in a strip shape. Continuous iron core piece 1 is formed by performing press punching on a soft magnetic steel plate having a strip shape. Each iron core piece 2 has a substantially fan shape (including a fan shape) in a top view. Arrow a in FIG. 1 indicates a traveling direction of the press punching (in other words, a longitudinal direction of continuous iron core piece 1). The plurality of iron core pieces 2 have the same size and the same shape. Iron core piece 2 has tooth portion 12 and yoke portion 20. One through-hole 5 is formed in yoke portion 20. As an example, FIG. 1 illustrates a case where the number of through-holes 5 is one. However, the present disclosure is not limited thereto. As an example, FIG. 1 illustrates a case where the number of tooth portions 12 is three. However, the present disclosure is not limited thereto.

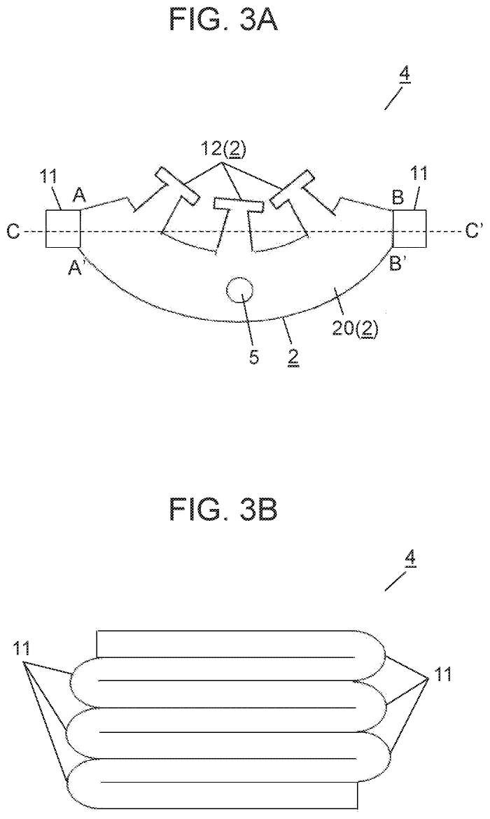

Iron core pieces 2 adjacent to each other are connected to each other via connection portion 3. Connection portion 3 is bent when laminated body 4 (refer to FIGS. 3A and 3B) (to be described later) is formed, and functions as a fold. For example, the fold corresponds to a perpendicular line orthogonal to a direction of arrow a in FIG. 1. Iron core pieces 2 adjacent to each other are provided line-symmetrically with reference to the fold of connection portion 3. That is, connection portion 3 can be a symmetry axis.

Continuous iron core piece 1 of Exemplary embodiment 1 is configured as described above.

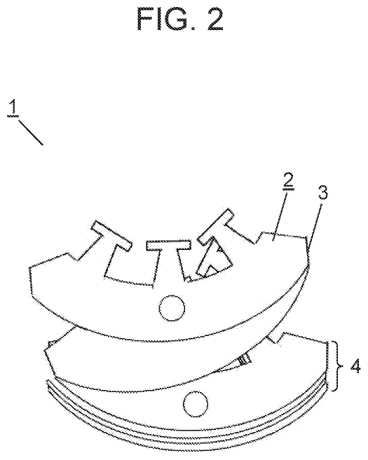

Hereinafter, a step of bending continuous iron core piece 1 of Exemplary embodiment 1 will be described with reference to FIGS. 2 to 3B.

FIG. 2 is an image diagram of the step of bending continuous iron core piece 1. FIG. 3A is a top view of laminated body 4. FIG. 3B is a side view of laminated body 4.

First, as illustrated in FIG. 2, connection portions 3 of continuous iron core piece 1 are respectively bent.

Connection portions 3 are respectively bent to form laminated body 4 illustrated in FIGS. 3A and 3B.

Hereinafter, laminated body 4 will be described.

As illustrated in FIG. 3A, laminated body 4 has side A-A′ (example of a first parallel portion) and side B-B′ (example of a second parallel portion) in bent portion 11 which are provided parallel to each other. Side A-A′ and side B-B′ are disposed to face each other in yoke portion 20. Bent portion 11 is cut along side A-A′ and side B-B′ as will be described later.

A straight line (hereinafter, referred to as a first virtual straight line) passing through a center of side A-A′ and orthogonal to side A-A′ and a straight line (hereinafter, referred to as a second virtual straight line) passing through a center of side B-B′ and orthogonal to side B-B′ coincide with each other, and form virtual straight line C-C′. That is, virtual straight line C-C′ is a straight line in which the first virtual straight line and the second virtual straight line coincide with each other.

Specifically, first, connection portions 3 illustrated in FIG. 1 are respectively bent as a symmetry axis. Outer edge portions of respective iron core pieces 2 are caused to coincide with each other, and respective iron core pieces 2 are superimposed on each other, thereby realizing the above-described relationship between side A-A′ and side B-B′. In this manner, as illustrated in FIG. 3A, when laminated body 4 is viewed from an upper surface, respective iron core pieces 2 are laminated in a substantially fan shape (including a fan shape) in a state having no deviation from each other.

For example, as a soft magnetic steel plate for forming continuous iron core piece 1, an amorphous alloy ribbon which is not subjected to heat treatment is used. For example, a thickness of the amorphous alloy ribbon is 0.01 mm to 0.1 mm. The amorphous alloy ribbon is an iron-based alloy containing at least one of boron and silicon. The amorphous alloy ribbon is manufactured through quenching as follows. A molten iron-based alloy described above is poured onto a surface of a rotating cooling drum, and is stretched into a ribbon shape.

In this case, when a steel plate is thinner, it is possible to reduce the amount of strain generated when connection portion 3 is bent. However, the amorphous alloy ribbon has many glide systems due to a crystal structure. Therefore, the amorphous alloy ribbon is likely to be bent, and can be bent by 180 degrees. That is, since continuous iron core piece 1 is formed by using the amorphous alloy ribbon, it is possible to easily realize a laminated state through a bending process of 180 degrees illustrated in FIG. 3B.

As described above, laminated body 24 is formed by bending continuous iron core piece 1 of Exemplary embodiment 1.

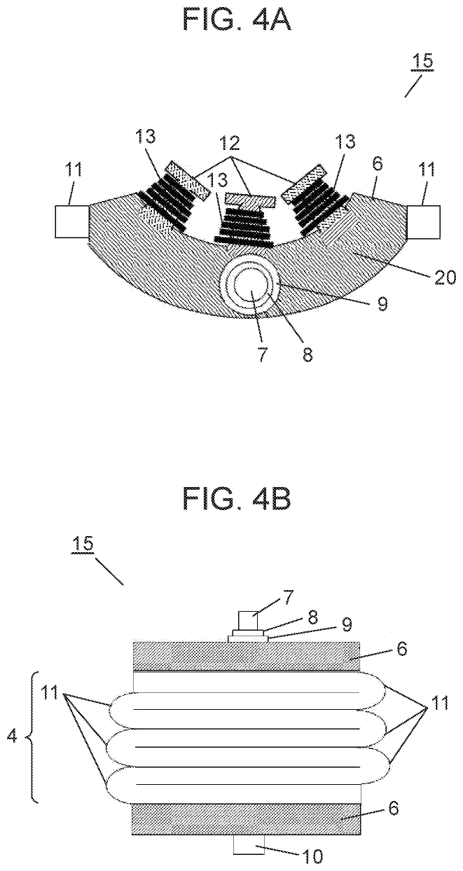

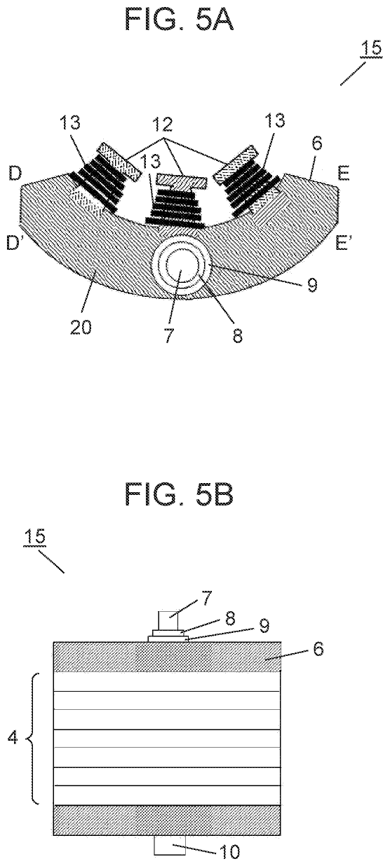

Hereinafter, a manufacturing method of split iron core 15 formed based on laminated body 4 will be described with reference to FIGS. 4A, 4B, 5A, and 5B.

FIGS. 4A and 5A are top views of split iron core 15. FIGS. 4B and 5B are side views of split iron core 15.

In the manufacturing method of split iron core 15, first, as illustrated in FIG. 4B, upper and lower portions of laminated body 4 are pinched between two metal plates 6. Metal plate 6 has a size and a shape which are the same as those of iron core piece 2. Here, although not illustrated, in FIG. 4B, metal plate 6 has tooth portion 12, yoke portion 20, and through-hole 5 (refer to FIGS. 3A and 4A).

Metal plate 6 is not an indispensable component. However, when iron core piece 2 is thin (for example, when a plate thickness is 0.1 mm or smaller), it is preferable that the upper and lower portions of laminated body 4 are pinched by metal plates 6. Since metal plates 6 pinch laminated body 4, a surface of laminated body 4 can be protected, and a compressive force in the laminating direction can be evenly transmitted inside a plane of laminated body 4. In this case, as metal plate 6, it is desirable to use a soft magnetic electromagnetic steel plate not to degrade magnetic properties.

Next, as illustrated in FIGS. 4A and 4B, bolt 7 is inserted into through-hole 5 (refer to FIG. 3A) via spring washer 8 and flat washer 9, and is fastened by nut 10.

Next, coil 13 is wound around tooth portion 12. Coil 13 is wound, and bolt 7 and nut 10 are fastened to each other. Accordingly, laminated body 4 and metal plate 6 are fixed to each other by receiving a pressure in the laminating direction (vertical direction in FIG. 4B). In this manner, laminated body 4 and metal plate 6 are brought into close contact with each other. In this case, bent portion 11 of laminated body 4 protrudes from an end surface side of metal plate 6.

Next, bent portion 11 protruding from metal plate 6 is cut. Specifically, bent portion 11 is cut along side A-A′ and side B-B′ which are illustrated in FIG. 3A. In this manner, split iron core 15 illustrated in FIGS. 5A and 5B is completely manufactured. Split iron core 15 is an example of the iron core of the present disclosure.

In this case, as described above, in split iron core 15, laminated body 4 and metal plate 6 are in close contact with each other by applying the pressure in the laminating direction. Therefore, when bent portion 11 is cut, only bent portion 11 can be easily cut and removed by machining work without damaging an interior of laminated body 4. In this manner, interlayer insulating properties of laminated body 4 (refer to FIG. 5B) are improved after bent portion 11 is cut, and magnetic properties of split iron core 15 are improved. External dimensions of split iron core 15 are reduced as much as the removed amount of bent portion 11. Dimensional accuracy of formed laminated body 4 can be improved.

As an example, FIG. 5A illustrates a configuration in which side D-D′ and side E-E′ which are formed by cutting bent portion 11 are parallel to each other. However, the present disclosure is not limited thereto. For example, when necessary, side D-D′ and side E-E′ of split iron core 15 may be processed into a preferable shape such as an inverted V-shape which is closed inward. In this manner, split iron core 15 which is widely useable can be formed.

Hitherto, a case where bent portion 11 is cut has been described as an example. However, the present disclosure is not limited thereto. For example, metal plate 6 may be configured to cover bent portion 11. In this case, bent portion 11 is in a remained state on a laminated end surface of laminated body 4. In this manner, it is possible to achieve an advantageous effect in that a laminated state is stabilized and layers are unlikely to deviate.

As described above, split iron core 15 of Exemplary embodiment 1 is manufactured. A plurality of manufactured split iron cores 15 are combined with each other, thereby manufacturing stator 19 below.

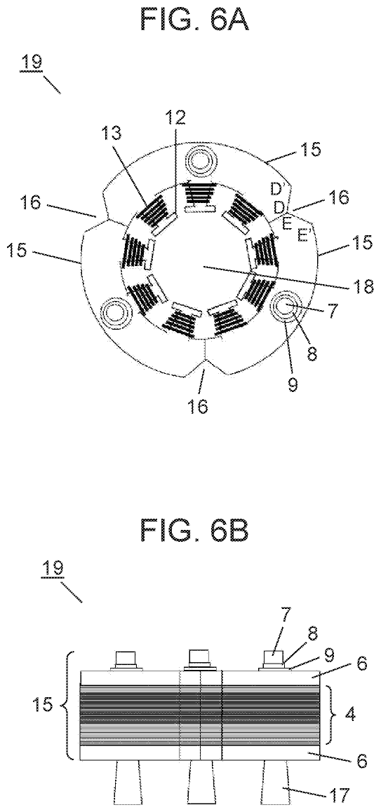

Hereinafter, stator 19 manufactured by combining the plurality of split iron cores 15 with each other will be described with reference to FIGS. 6A and 6B.

FIG. 6A is a top view of stator 19. FIG. 6B is a side view of stator 19.

As illustrated in FIG. 6A, stator 19 is formed by combining three split iron cores 15 with each other in an annular shape. In this manner, as illustrated in FIG. 6A, hollow portion 18 is formed in a central portion of stator 19. As illustrated in FIG. 6B, each of split iron cores 15 is fixed to base 17 by bolt 7.

As illustrated in FIG. 6A, cutout portion 16 is formed between side D-D′ and side E-E′ in an outer peripheral portion of a boundary between split iron cores 15 adjacent to each other (which may be called laminated body 4).

Stator 19 configured as described above can be used for a motor. That is, a rotor (not illustrated) is disposed in hollow portion 18 of stator 19, and electric power is supplied to the rotor via an electrical wire. In this manner, stator 19 can function as a portion of components of the motor.

In this case, for example, the electrical wire or a rib of an exterior housing of the motor can be disposed in cutout portion 16 described above. In this manner, a reduced size of the motor including an exterior can be realized.

Hitherto, a case where stator 19 is configured to include three split iron cores 15 has been described as an example. However, the present disclosure is not limited thereto. For example, the number of split iron cores 15 configuring stator 19 may be other than three.

Hitherto, a case where stator 19 is used for the motor has been described as an example. However, the present disclosure is not limited thereto. For example, stator 19 is also applicable to an electronic component adopting magnetism of a transformer. The same applies to Exemplary embodiment 2 to Exemplary embodiment 4 to be described below.

### Exemplary Embodiment 2

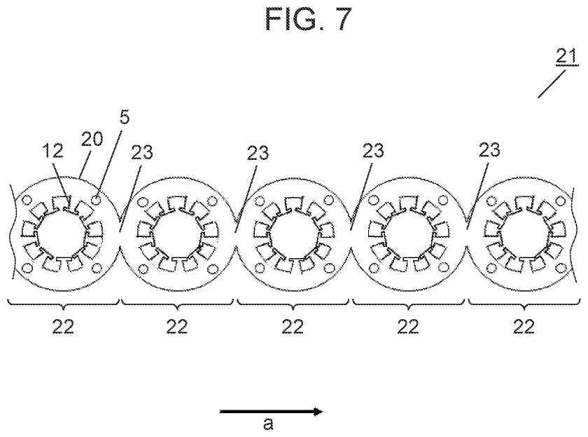

Hereinafter, continuous iron core piece 21 of Exemplary embodiment 2 will be described with reference to FIG. 7. FIG. 7 is a top view of continuous iron core piece 21.

As illustrated in FIG. 7, continuous iron core piece 21 is a member in which a plurality of iron core pieces 22 are connected to each other in a strip shape. Continuous iron core piece 21 is formed by performing press punching on a soft magnetic steel plate having a strip shape. Each iron core piece 22 has a substantially circular shape (including a circular shape) in a top view. Arrow a in FIG. 7 indicates a traveling direction of press punching (in other words, a longitudinal direction of continuous iron core piece 21).

The plurality of iron core pieces 22 have the same size and the same shape. Iron core piece 22 has tooth portion 12 and yoke portion 20. Four through-holes 5 are formed in yoke portion 20. As an example, FIG. 7 illustrates a case where the number of through-holes 5 is four. However, the present disclosure is not limited thereto. As an example, FIG. 7 illustrates a case where the number of tooth portions 12 is nine. However, the present disclosure is not limited thereto.

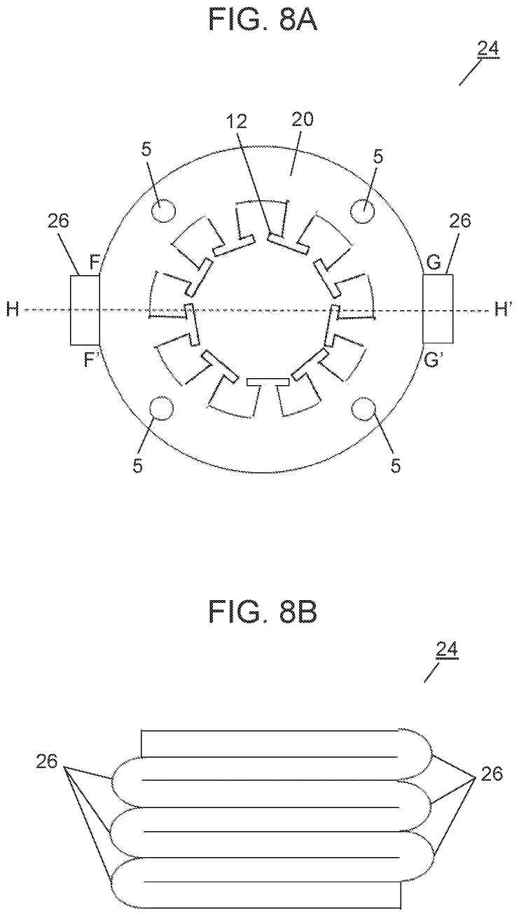

Iron core pieces 22 adjacent to each other are connected to each other via connection portion 23. Connection portion 23 is bent when laminated body 24 (refer to FIGS. 8A and 8B) (to be described later) is formed, and functions as a fold. For example, the fold corresponds to a perpendicular line orthogonal to a direction of arrow a in FIG. 7. Iron core pieces 22 adjacent to each other are provided line-symmetrically with reference to the fold of connection portion 23. That is, connection portion 23 can be a symmetry axis.

Continuous iron core piece 21 of Exemplary embodiment 2 is configured as described above.

Hereinafter, laminated body 24 formed by bending continuous iron core piece 21 of Exemplary embodiment 2 will be described.

First, respective connection portions 23 of continuous iron core pieces 21 illustrated in FIG. 7 are bent as a symmetry axis. In this manner, laminated body 24 illustrated in FIGS. 8A and 8B is formed.

Hereinafter, laminated body 24 will be specifically described with reference to FIGS. 8A and 8B.

FIG. 8A is a top view of laminated body 24. FIG. 8B is a side view of laminated body 24.

As illustrated in FIG. 8A, laminated body 24 has side F-F′ (example of a first parallel portion) and side G-G′ (example of a second parallel portion) in bent portion 26 which are provided parallel to each other. Side F-F′ and side G-G′ are disposed to face each other in yoke portion 20. Bent portion 26 is cut along side F-F′ and side G-G′ as will be described later.

A straight line (hereinafter, referred to as a third virtual straight line) passing through a center of side F-F′ and orthogonal to side F-F′ and a straight line (hereinafter, referred to as a fourth virtual straight line) passing through a center of side G-G′ and orthogonal to side G-G′ coincide with each other, and form virtual straight line H-H′. That is, virtual straight line H-H′ is a straight line in which the third virtual straight line and the fourth virtual straight line coincide with each other.

Specifically, first, respective connection portions 23 illustrated in FIG. 7 are bent as a symmetry axis. Outer edge portions of respective iron core pieces 22 are caused to coincide with each other, and respective iron core pieces 22 are superimposed on each other, thereby realizing the above-described relationship between side F-F′ and side G-G′. In this manner, as illustrated in FIG. 8A, when laminated body 24 is viewed from an upper surface, respective iron core pieces 22 are laminated in a substantially annular shape (including an annular shape) in a state having no deviation from each other.

As described above, laminated body 24 is formed by bending continuous iron core piece 21 of Exemplary embodiment 2.

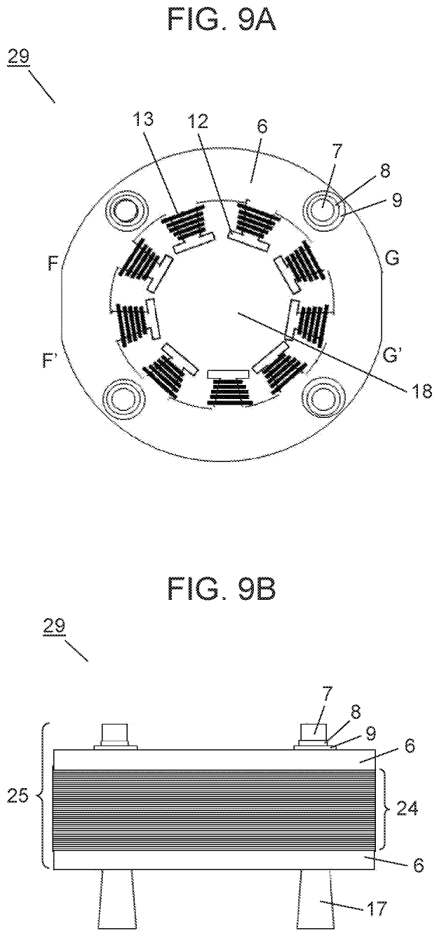

Integrated iron core 25 (refer to FIG. 9B) is manufactured, based on laminated body 24 described above. A manufacturing method of integrated iron core 25 is the same as that in Exemplary embodiment 1.

In the manufacturing method of integrated iron core 25, first, upper and lower portions of laminated body 24 are pinched between two metal plates 6.

Next, bolt 7 is inserted into through-hole 5 (refer to FIG. 8A) via spring washer 8 and flat washer 9, and is fastened to base 17.

Next, coil 13 is wound around tooth portion 12.

Next, bent portion 26 protruding from metal plate 6 is cut. Specifically, bent portion 26 is cut along side F-F′ and side G-G′ which are illustrated in FIG. 8A. In this manner, integrated iron core 25 illustrated in FIG. 9B is completely manufactured. Integrated iron core 25 is an example of the iron core of the present disclosure.

Coil 13 is wound, and bolt 7 and nut 10 are fastened to each other. Accordingly, laminated body 24 and metal plate 6 are fixed to each other by receiving a pressure in the laminating direction (vertical direction in FIG. 9B). In this manner, laminated body 4 and metal plate 6 are brought into close contact with each other. Therefore, when bent portion 26 is cut, only bent portion 26 can be easily cut and removed by machining work without damaging an interior of laminated body 24. In this manner, interlayer insulating properties of laminated body 24 (refer to FIG. 9B) are improved after bent portion 26 is cut, and magnetic properties of integrated iron core 25 are improved. External dimensions of integrated iron core 25 are reduced as much as the removed amount of bent portion 26. Dimensional accuracy of formed laminated body 24 can be improved.

Hitherto, a case where bent portion 26 is cut has been described as an example. However, the present disclosure is not limited thereto. For example, metal plate 6 may be configured to cover bent portion 26. In this case, bent portion 26 is in a remained state on a laminated end surface of laminated body 24. In this manner, it is possible to achieve an advantageous effect in that a laminated state is stabilized and layers are unlikely to deviate.

As described above, integrated iron core 25 of Exemplary embodiment 2 is manufactured. Stator 29 is manufactured by using manufactured and integrated iron core 25.

Hereinafter, stator 29 manufactured by using integrated iron core 25 will be described with reference to FIGS. 9A and 9B.

FIG. 9A is a top view of stator 29. FIG. 9B is a side view of stator 29.

As illustrated in FIG. 9A, hollow portion 18 is formed in a central portion of stator 29. As illustrated in FIG. 9B, stator 29 is fixed to base 17 by bolt 7.

FIG. 9A illustrates an example in which side F-F′ and side G-G′ which are formed by cutting bent portion 26 are parallel to each other. However, the present disclosure is not limited thereto. For example, when necessary, side F-F′ and side G-G′ of integrated iron core 25 may be processed into a preferable shape such as a circular curved surface. In this manner, split iron core 15 which is widely useable can be formed.

Stator 29 configured as described above can be used for a motor. That is, a rotor (not illustrated) is disposed in hollow portion 18 of stator 29, and electric power is supplied to the rotor via an electrical wire. In this manner, stator 29 can function as a portion of components of the motor.

As described above, in Exemplary embodiment 2, stator 29 is configured by using integrated iron core 25. Therefore, a material yield is lowered by punching hollow portion 18. However, unlike Exemplary embodiment 1, it is not necessary to combine the plurality of split iron cores 15 with each other to configure stator 29. That is, in completely manufactured stator 29, there is no seam between the iron cores. Therefore, a continuous magnetic path is formed in stator 29. In this manner, magnetic properties of stator 29 can be improved.

### Exemplary Embodiment 3

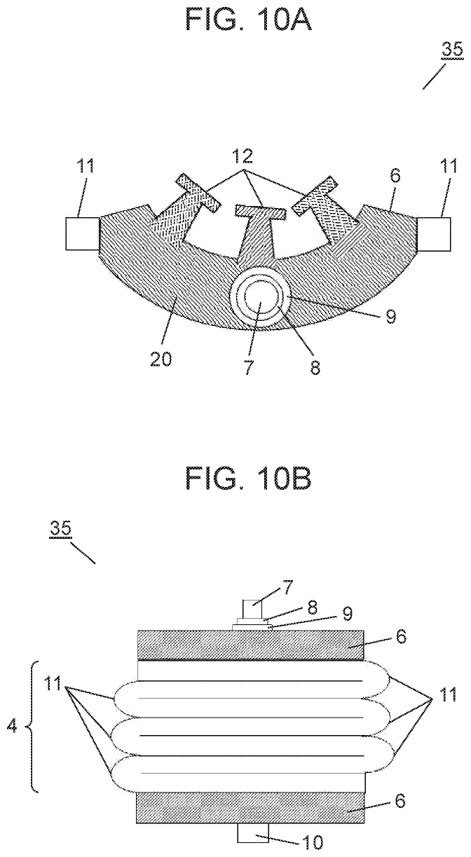

Hereinafter, a manufacturing method of split iron core 35 according to Exemplary embodiment 3 will be described with reference to FIGS. 10A, 10B, 11A, 11B, 12A, and 12B.

FIGS. 10A, 11A, and 12A are top views of split iron core 35. FIGS. 10B, 11B, and 12B are side views of split iron core 35.

Here, as illustrated in FIGS. 10A and 10B, split iron core 35 of Exemplary embodiment 3 is manufactured by using continuous iron core piece 1 (refer to FIG. 1) described in Exemplary embodiment 1 and laminated body 4 (refer to FIGS. 3A and 3B) manufactured by using continuous core piece 1. However, as illustrated in FIG. 10A, coil 13 is not provided in split iron core 35 when laminated body 4 is manufactured.

A step of manufacturing split iron core 35 in a state illustrated in FIGS. 10A and 10B is the same as that of Exemplary embodiment 1 except for a step of winding coil 13 around tooth portion 12. Accordingly, description thereof will be omitted here.

That is, in Exemplary embodiment 3, laminated body 4 is first subjected to heat treatment in split iron core 35 in states illustrated in FIGS. 10A and 10B. Through the heat treatment, soft magnetic properties of laminated body 4 (specifically, an amorphous alloy ribbon which is a material of continuous iron core piece 1) can be improved. Thereafter, coil 13 is wound around each tooth portion 12. As a result, split iron core 35 which is an example of the iron core of the present disclosure is formed.

In general, when laminated body 4 is subjected to the heat treatment in a state where coil 13 is provided in tooth portion 12, the following properties may be deteriorated. Specifically, first, due to annealing, tension of coil 13 may decrease, and coil 13 wound around tooth portion 12 may be loosened in some cases. Depending on a temperature of the heat treatment for laminated body 4, an insulating film on an outer periphery of coil 13 may be melted, and insulating properties may be degraded in some cases. Therefore, when the heat treatment is performed, as described above, it is preferable to provide coil 13 in tooth portion 12 after laminated body 4 is subjected to the heat treatment. However, depending on a configuration material of a coil having a heat resistant temperature higher than the temperature of heat treatment, such as a fluorine-based resin, the heat treatment can be performed in a state where coil 13 is provided. In that case, for example, it is more desirable to perform the heat treatment on laminated body 4 at 100° C. or lower.

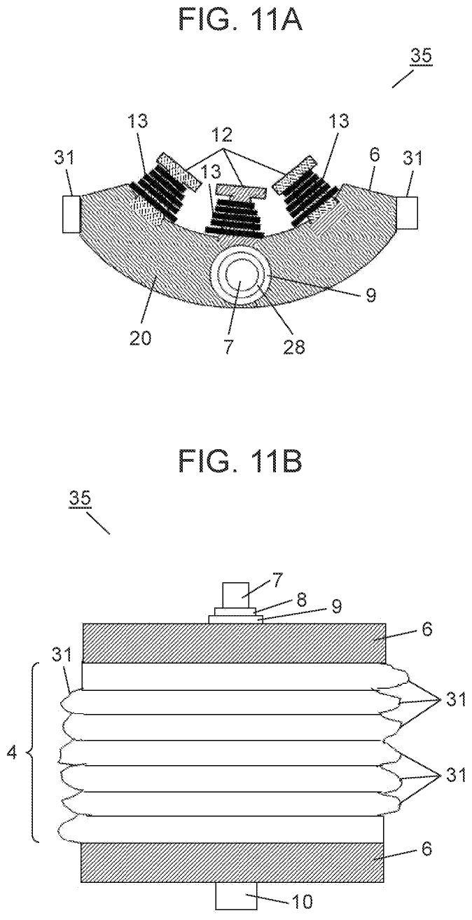

The heat treatment is performed, and split iron core 35 in which coil 13 is wound around tooth portion 12 is brought into states illustrated in FIGS. 11A and 11B.

In this case, an amorphous ribbon configuring bent portion 11 which is not covered with metal plate 6 is brittle due to the heat treatment. Since coil 13 is wound, a stronger compressive force acts in the laminating direction (vertical direction in FIG. 11B). Therefore, bent portion 11 illustrated in FIGS. 10A and 10B is broken. In this manner, as illustrated in FIGS. 11A and 11B, residual portion 31 protruding from an end surface of laminated body 4 is formed.

Residual portion 31 indicates a brittle fracture surface. On the other hand, an interior of laminated body 4 is compressed and fixed. Therefore, laminated body 4 is not damaged, or is not misaligned in an in-plane direction.

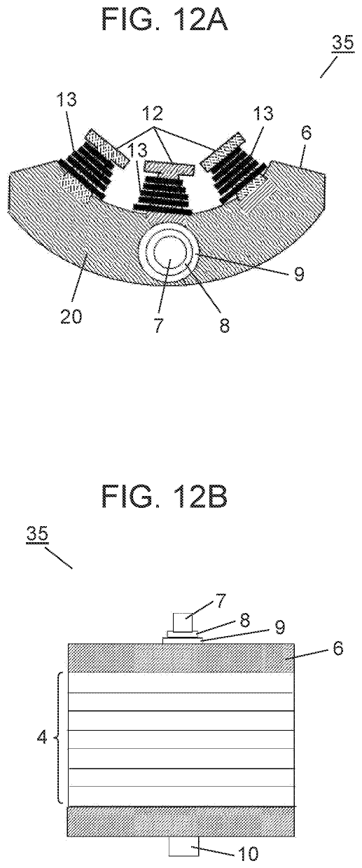

Next, with respect to split iron core 35 in states illustrated in FIGS. 11A and 11B, residual portion 31 is cut along the end surface of laminated body 4 by machining work. In this manner, split iron core 35 is brought into states illustrated in FIGS. 12A and 12B.

Split iron core 35 illustrated in FIGS. 12A and 12B is used in manufacturing stator 19 (refer to FIGS. 6A and 6B) described in Exemplary embodiment 1. Description on the manufacturing method of stator 19 is the same as that in Exemplary embodiment 1, and thus, repeated description will be omitted.

### Exemplary Embodiment 4

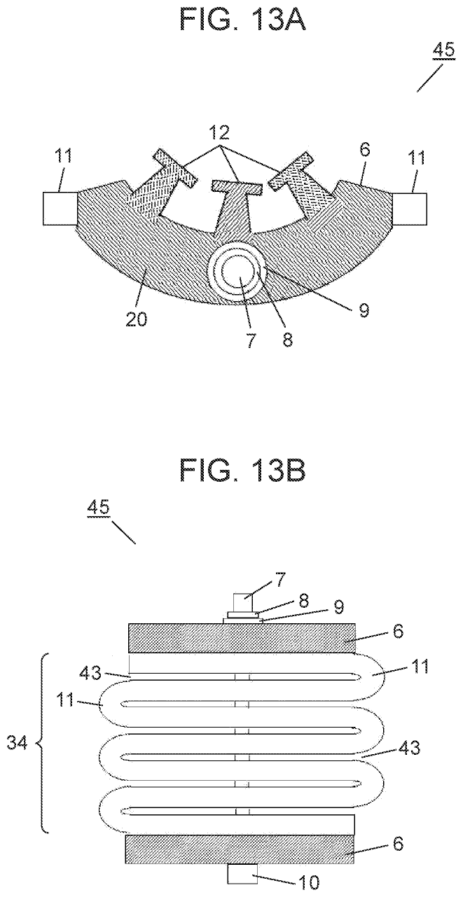

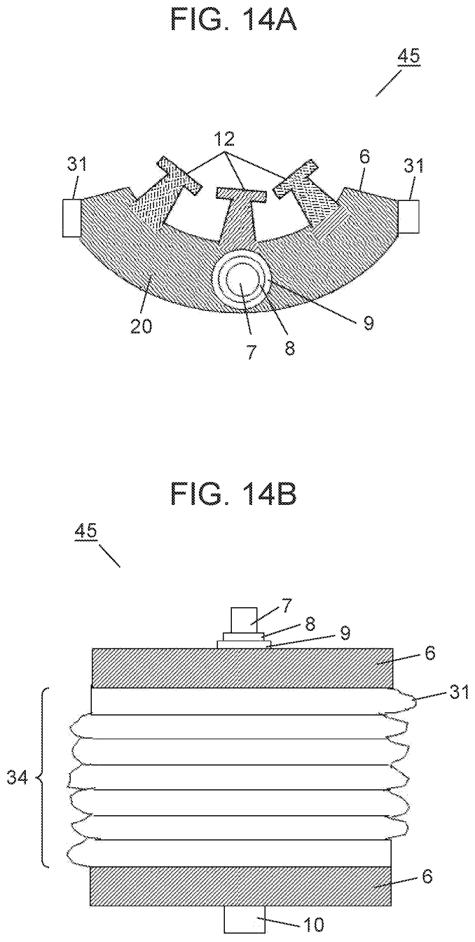

Hereinafter, a manufacturing method of split iron core 45 of Exemplary embodiment 4 will be described with reference to FIGS. 13A, 13B, 14A, and 14B.

FIGS. 13A and 14A are top views of split iron core 45. FIGS. 13B and 14B are side views of split iron core 45.

Here, as illustrated in FIGS. 13A and 13B, split iron core 45 of Exemplary embodiment 4 is manufactured by using laminated body 34 manufactured by using continuous iron core piece 1 (refer to FIG. 1) described in Exemplary embodiment 1.

Laminated body 34 of Exemplary embodiment 4 has a plurality of gaps 43 as illustrated in FIG. 13B. That is, laminated body 34 is formed by bending each connection portion 3 (refer to FIG. 1) so that each gap 43 is provided.

As illustrated in FIG. 13A, as in Exemplary embodiment 3, coil 13 is not provided in split iron core 45 when laminated body 4 is manufactured.

A step of manufacturing split iron core 35 in states illustrated in FIGS. 13A and 13B is the same as that of Exemplary embodiment 1 except for a step of winding coil 13 around tooth portion 12. Accordingly, description thereof will be omitted here.

In split iron core 45 of Exemplary embodiment 4 in states illustrated in FIGS. 13A and 13B, when split iron core 45 is unfixed in the laminating direction (vertical direction in FIG. 13B), gap 43 is also formed in a boundary between metal plate 6 and laminated body 34.

That is, in Exemplary embodiment 4, as in Exemplary embodiment 3, laminated body 34 is first subjected to the heat treatment in split iron core 45 in states illustrated in FIGS. 13A and 13B. Through the heat treatment, soft magnetic properties of laminated body 34 (specifically, an amorphous alloy ribbon which is a material of continuous iron core piece 1) can be improved.

The heat treatment is performed in a state where gap 43 is provided between layers of laminated body 34. Accordingly, an oxide film on a surface of the amorphous alloy ribbon further grows. In this manner, interlayer insulating properties of laminated bodies 34 are further improved. Accordingly, magnetic properties of the iron core are further improved. In this case, although the heat treatment depends on a chemical composition of the amorphous alloy ribbon, for example, when the temperature of the heat treatment is approximately 300° C. or lower, the amorphous alloy ribbon remains in an amorphous phase as a whole. For example, when the temperature of the heat treatment is in a range of 400° C. to 500° C., a nano-crystal grain is generated from the amorphous phase. In this case, self-heating occurs when the nano-crystal grain is generated from the amorphous phase. When the laminated body 34 is subjected to the heat treatment in a state having no gap 43, heat generated by the self-heating is accumulated between the amorphous alloy ribbons. Therefore, it becomes difficult to control the temperature of the amorphous alloy ribbon, and the temperature excessively rises.

Therefore, in laminated body 34 of Exemplary embodiment 4, gap 43 is provided between the layers. When laminated body 34 is subjected to the heat treatment in a state where gap 43 is provided, the heat generated by the self-heating escapes outward through gap 43. In this manner, it is possible to prevent excessive temperature rise of laminated body 34. In particular, in a case of the heat treatment using hot air, air having a predetermined temperature passes through gap 43. Accordingly, the temperature is more easily controlled. Therefore, it is more preferable to perform the heat treatment using the hot air.

After the above-described heat treatment is performed, bolt 7 is further tightened. In this manner, a pressure is further applied to laminated body 34 in the laminating direction. As a result, split iron core 45 is brought into states illustrated in FIGS. 14A and 14B.

As illustrated in FIGS. 14A and 14B, misalignment in each layer and in the in-plane direction of laminated body 34 is suppressed. In this manner, laminated body 34 is compressed and fixed in the laminating direction (vertical direction in FIG. 14B). In this case, as illustrated in FIGS. 13A and 13B, bent portion 11 is broken. In this manner, as illustrated in FIGS. 14A and 14B, residual portion 31 protruding from the end surface of laminated body 34 is formed.

Residual portion 31 indicates a brittle fracture surface. On the other hand, the interior of laminated body 34 is compressed and fixed. Therefore, laminated body 34 is not damaged, or is not misaligned in the in-plane direction.

Thereafter, in split iron core 45 in states illustrated in FIGS. 14A and 14B, coil 13 is wound around tooth portion 12, and residual portion 31 is cut. In this manner, split iron core 45 which is in the same state as that of split iron core 35 illustrated in FIGS. 12A and 12B is completely manufactured. Thereafter, a coil (not illustrated) is wound around each tooth portion 12. In this manner, split iron core 45 is completely manufactured. Split iron core 45 is an example of the iron core of the present disclosure.

Split iron core 45 completely manufactured as described above is used in manufacturing stator 19 (refer to FIGS. 6A and 6B) described in Exemplary embodiment 1. Description on the manufacturing method of stator 19 is the same as that in Exemplary embodiment 1, and thus, repeated description will be omitted.

As described above, split iron core 15, integrated iron core 25, split iron core 35, and split iron core 45 which are described in Exemplary embodiment 1 to Exemplary embodiment 4 are examples of the iron core.

As described above, in iron cores (15, 25, 35, and 45) according to the above-described respective embodiments, the plurality of iron core pieces (2 and 22) including tooth portion (12) and yoke portion (20) are connected in a strip shape. Iron core pieces (2 and 22) adjacent to each other are connected to each other by connection portions (3 and 23), and continuous iron core pieces (1 and 21) provided line-symmetrically with reference to connection portions (3 and 23) are formed. Laminated bodies (4, 24, and 34) are formed by bending and superimposing iron core pieces (1 and 21) adjacent to each other while connection portions (3 and 23) are used as the symmetry axis. The pressure is applied to fix laminated bodies (4, 24, and 34) in the laminating direction, and coil (13) is provided in tooth portion (12). In this manner, iron cores (15, 25, 35, and 45) are manufactured.

That is, according to the above-described respective embodiments, it is possible to realize the manufacturing method of the iron core, the iron core, and the stator, which have a high material yield, high productivity, and excellent magnetic properties by using the thin iron core piece.

The present disclosure is not limited to the description of the above-described respective embodiments, and various modifications can be made within the scope not departing from the concept of the present disclosure.

What is claimed is:

1. A manufacturing method of manufacturing an iron core, comprising:
forming a continuous iron core piece in which a plurality of iron core pieces each including a tooth portion and a yoke portion are connected in a strip shape and the iron core pieces adjacent to each other are connected by a connection portion, and which is provided line-symmetrically with reference to the connection portion;
forming a laminated body by bending and superimposing the iron core pieces adjacent to each other while the connection portion is used as a symmetry axis;
applying a pressure in a laminating direction of the laminated body to fix the laminated body; and
providing a coil in the tooth portion.

2. The manufacturing method of an iron core of claim 1,
wherein the continuous iron core piece is formed from an amorphous alloy ribbon.

3. The manufacturing method of an iron core of claim 1,
wherein the laminated body is formed by using the continuous iron core piece formed from an amorphous alloy ribbon which is not subjected to heat treatment, and
the method further comprises causing metal plates to pinch upper and lower surfaces of the laminated body in the laminating direction, and
performing the heat treatment on the laminated body and the metal plates.

4. The manufacturing method of an iron core of claim 3,
wherein the heat treatment is performed in a state where the pressure is applied in the laminating direction of the laminated body.

5. The manufacturing method of an iron core of claim 3,
wherein a gap is provided between respective layers of the laminated body, and
the heat treatment is performed in a state where the gap is provided.

6. The manufacturing method of an iron core of claim 1, further comprising:
removing a bent portion formed by bending the connection portion in a state where the pressure is applied in the laminating direction of the laminated body.

7. An iron core comprising:
a laminated body including a tooth portion and a yoke portion; and
a coil provided in the tooth portion,
wherein the laminated body is formed by a continuous iron core piece in which a plurality of iron core pieces including the tooth portion and the yoke portion are connected in a strip shape and the iron core pieces adjacent to each other are connected by a connection portion, and which is provided line-symmetrically with reference to the connection portion, and
the laminated body is formed by bending and superimposing the iron core pieces adjacent to each other while the connection portion is used as a symmetry axis.

8. The iron core of claim 7,
wherein the laminated body has a first parallel portion and a second parallel portion which face each other in the yoke portion, and
the laminated body is configured so that a perpendicular line passing through a center of the first parallel portion and orthogonal to the first parallel portion and a perpendicular line passing through a center of the second parallel portion and orthogonal to the second parallel portion coincide with each other.

9. The iron core of claim 7,
wherein an end surface of the laminated body is formed in a state where a bent portion formed by bending the connection portion remains.

10. The iron core of claim 7,
wherein an end surface of the laminated body is formed in a state where a bent portion formed by bending the connection portion is removed.

11. The iron core of claim 7,
wherein the continuous iron core piece has a plate thickness of 0.01 mm to 0.1 mm, and is formed from an amorphous alloy ribbon.

12. The iron core of claim 11,
wherein the amorphous alloy ribbon is subjected to heat treatment.

13. The iron core of claim 12,
wherein the amorphous alloy ribbon subjected to the heat treatment is amorphous as a whole.

14. The iron core of claim 12,
wherein the amorphous alloy ribbon subjected to the heat treatment has a nano-crystal grain.

15. The iron core of claim 7, further comprising:
metal plates that pinch upper and lower surfaces of the laminated body in the laminating direction.

16. The iron core of claim 15,
wherein the metal plate is an electromagnetic steel plate.

17. The iron core of claim 7,
wherein the laminated body has a substantially annular shape in a top view.

18. The iron core of claim 7,
wherein the laminated body has a substantially fan shape in a top view, and
a plurality of laminated bodies each being the laminated body are formed in combination in an annular shape in a top view.

19. The iron core of claim 18,
wherein a cutout portion is provided in an outer peripheral portion of a boundary between the laminated bodies adjacent to each other.

20. A stator comprising:
the iron core of claim 7.
